(19) United States
(12) Patent Application Publication
(10) Pub. No.: US 2022/0312133 A1
(43) Pub. Date: Sep. 29, 2022

(54) Ear Level Part for a Hearing Device

(71) Applicant: SONOVA AG, Staefa (CH)

(72) Inventors: Rafael Tamsiran, Amersfoort (NL); Simon Kohler, Staefa (CH)

(21) Appl. No.: 17/692,781

(22) Filed: Mar. 11, 2022

(30) Foreign Application Priority Data
Mar. 23, 2021 (EP) EP21164262

(51) Int. Cl. H04R 25/00

(52) U.S. Cl. CPC H04R 25/652; H04R 2225/021; H04R 2225/57; H04R 2225/025

(57) ABSTRACT

An ear level part for a hearing device includes a body configured to be worn within a concha of a user's ear and a retention element arranged on the body and configured to bear against an antihelix of the user's ear, wherein a cable is arranged to electrically connect the ear level part with a behind the ear part of the hearing device, wherein the cable is run within the retention element and emerges from an end section thereof.

### RELATED APPLICATIONS

The present application claims priority to EP Patent Application No. EP21164262, filed Mar. 23, 2021, the contents of which are hereby incorporated by reference in their entirety.

### BACKGROUND INFORMATION

Hearing devices, in particular for hearing impaired people, are known in the art. In so called Receiver-in-the-Canal (RIC) hearing devices, a speaker is placed within a hearing canal and connected by a cable to an on-the-ear component or behind-the-ear component. In the domain of hearing devices the speaker is referred to as a receiver.

A hearing instrument with robust and stable active noise cancelling technology requires a certain speaker size in the ear piece. Such an ear piece is typically much larger compared to traditional hearing instrument speakers/receivers. If the hearing instrument is designed for full day use, resulting requirements on wearing comfort and battery lifetime lead to a design which is not completely in the concha but partially in the concha (e.g. speaker, microphones) and partially behind the ear (e.g. digital sound processor, battery, antenna). Like in traditional so-called RIC (receiver in canal) hearing instruments, a cable is required to connect the concha/ITE (in the ear) and BTE (behind the ear) parts. In contrast to the traditional RIC hearing instruments, the speaker/receiver of the ANC hearing instrument is much larger, which makes it hard to position the ear piece deep in the ear canal. Typical resulting ear piece designs are positioned less in the ear canal and more in the concha. Such a design typically requires a so-called retention element, to hold the ear piece in place, to ensure a good sealing/coupling of the ear piece to the ear canal and to prevent the ear piece from falling out of the ear.

There remains a need for an improved hearing device.

### BRIEF DESCRIPTION OF THE DRAWINGS

The present invention will become more fully understood from the detailed description given hereinbelow and the accompanying drawings which are given by way of illustration only, and thus, are not limitative of the present invention, and wherein:

FIG. 1 is a schematic view of a hearing device comprising an ear level part and a behind the ear part,

FIG. 2 is a schematic view of the ear level part,

FIG. 3 is a schematic view of an ear with the hearing device installed,

FIG. 4 is a schematic sectional view of a cable,

FIG. 5 is a schematic diagram showing crosstalk for different conductor/signal assignments, and

FIG. 6 is a schematic view of a hearing device having a transducer module and a cable according to FIG. 4.

Corresponding parts are marked with the same reference symbols in all figures.

### DETAILED DESCRIPTION

Embodiments described herein relate to an ear level part for a hearing device.

It is an aspect of the present disclosure to provide an improved ear level part for a hearing device and an improved hearing device.

The aspect is achieved by an ear level part for a hearing device as described herein.

An ear level part for a hearing device may include a body configured to be worn within a concha of a user's ear and a retention element arranged on the body and configured to bear against an antihelix of the user's ear, wherein a cable is arranged to electrically connect the ear level part with a behind the ear part of the hearing device, wherein the cable is run within the retention element and emerges from an end section thereof.

In an exemplary embodiment, the retention element has an arc shape running around part of a circumference of the body.

In an exemplary embodiment, the retention element emerges from the body in a tangential or nearly tangential way, e.g. less than 10° or less than 15° or less than 20° deviating from an imaginary tangent line on the circumference of the body.

In an exemplary embodiment, a distance between the body and the retention element increases over at least part of a course of the retention element.

In an exemplary embodiment, the retention element has a generally oval cross section in a transverse direction to its course at least over a part of its course.

In an exemplary embodiment, a course of the retention element is adapted to at least in part follow a course of the antihelix when the body of the ear level part is arranged in the concha.

In an exemplary embodiment, an end section of the retention element opposite an end emerging from the body is configured to at least approximately point toward an incisura anterior of the ear when the body of the ear level part is arranged in the concha thereof.

In an exemplary embodiment, the retention element is integrally formed with the body.

In an exemplary embodiment, the retention element and/or the body are/is made of die cast silicone having a shore A hardness of less than 50.

In an exemplary embodiment, a groove is arranged in the retention element, the groove following the course of the retention element and configured to receive the cable.

In an exemplary embodiment, a width of the groove and a diameter of the cable are chosen to provide a tight fit.

In an exemplary embodiment, the groove is arranged in a medial side of the retention element.

In an exemplary embodiment, the cable is a flexible cable.

In an exemplary embodiment, at least one of two ends of the cable is equipped with a plug.

In an exemplary embodiment, a dome is arranged at a medial end of the body, the dome comprising a socket and a collar, the collar arranged at a medial end of the socket generally extending back in a distal direction thus at least partially enclosing the socket, wherein the collar is configured to flare in the distal direction.

In an exemplary embodiment, the ear level part is part of a hearing device, further comprising a behind the ear part electrically connected to the ear level part by the cable.

The embodiments described herein solve the problem that both the cable and the retention element add size to the ear piece making it look more complex and less integrated and thus less appealing. Furthermore, if the cable is separate from the retention element, the two elements could interfere with each other, which in the design could lead to an anatomical non-optimal position/orientation of one of these elements.

Further scope of applicability of the embodiments described herein will become apparent from the detailed description given hereinafter. However, it should be understood that the detailed description and specific examples, while indicating illustrative embodiments, are given by way of illustration only, since various changes and modifications within the spirit and scope of the embodiments described herein will become apparent to those skilled in the art from this detailed description.

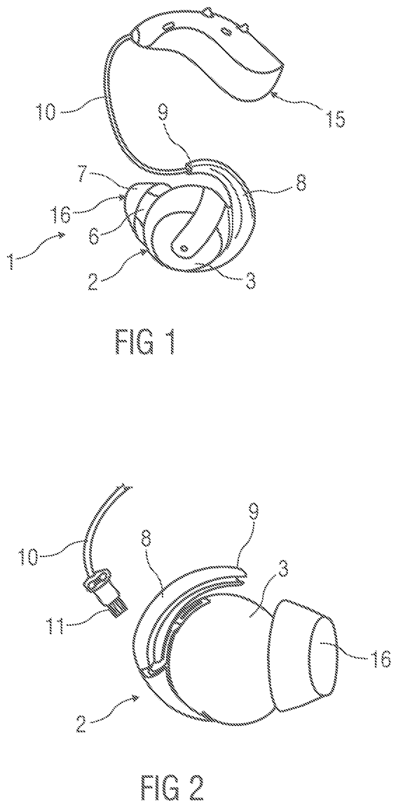

FIG. 1 is a schematic view of a hearing device 1 comprising an ear level part 2 and a behind the ear part 15. FIG. 2 is a schematic view of the ear level part 2.

The ear level part 2 is configured to be at least partially inserted into an ear canal of a user or an entrance of the ear canal and comprises a body 3 configured to receive electronic components, in particular one or more microphones and a speaker which is also referred to as a receiver. Moreover, the electronic components may comprise circuitry configured to perform active noise cancelling. The body 3 may generally have an oval cross section, e.g. a circular or elliptic cross section.

At a medial end of the body 3, i.e. an end which points in a medial direction when the ear level part 2 is in place within a user's ear 20, a dome 16 may be arranged, in particular releasably and/or replaceably arranged on a flange of the body 3. The dome 16 may comprise a socket 6 and a collar 7, the collar 7 being arranged at a medial end of the socket 6 generally extending back in a distal direction thus at least partially enclosing the socket 6, wherein the collar 7 may be configured to flare in the distal direction, wherein the socket 6 is releasably connected with the flange of the body 3 thus connecting the dome 16 to the body 3. The socket 6 may have an oval cross section, e.g. a circular or elliptic cross section. The oval cross section may be inherent to the socket 6 or a result of the socket 6 being arranged on an oval collar portion of the flange of the body 3. The flange may hold the receiver or be configured as an acoustic channel for propagating sound emitted by the receiver if the receiver is arranged within the body 3.

The dome 16 or the collar 7 may be made of a flexible material such as soft silicone rubber such that the collar 7 can accommodate to the shape of an ear canal or an entrance thereof. The fact that the collar 7 flares when in the relaxed state facilitates retaining the ear level part 2 in an ear 20 of a user. The body 3 may be made from the same material or from a different material than the dome 16.

A retention element 8 is arranged on the body 3, wherein the retention element 8 has an arc shape which is not necessarily a circular arc. The retention element 8 may be integrally formed with the body 3 and emerge from the body 3 in a tangential or nearly tangential way, wherein the retention element 8 is then run around part of a circumference of the body 3, e.g. about 90° to 200° of the circumference, while a distance between the body 3 and the retention element 8 may increase over at least part of this course. The retention element 8 may have a generally oval cross section in a transverse direction to its course, e.g. a circular, elliptic or otherwise round cross section, at least beginning at a point where the retention element 8 starts being at a distance from the body 3. In particular, the course of the retention element 8 may be chosen to at least in part follow a course of an antihelix 26 of the user's ear 20 when the body 3 of the ear level part 2 is arranged in a concha 21 thereof. An end section 9 of the retention element 8 opposite the end emerging from the body 3 may have a higher curvature than the part following the antihelix 26 thus reapproaching the body 3 so as to at least approximately point toward the incisura anterior 27 of the ear 20.

In an ear level part 2 for a left ear the retention element 8 may originate from the body 3 and run in the counterclockwise direction when looking in the medial direction. In an ear level part 2 for a right ear the retention element 8 may originate from the body 3 and run in the clockwise direction when looking in the medial direction.

Furthermore, a cable 10 is arranged to electrically connect the ear level part 2 with the behind the ear part 15. The cable 10 is run within the retention element 8 and emerges from the end section 9 thereof, e.g. toward the incisura anterior 27.

The cable 10 may be a flexible cable, e.g. a plastically deformable cable, in particular configured as described in EP 3 758 393 A1 which is hereby incorporated by reference in its entirety.

Running the cable 10 within the retention element 8 results in a more integrated design, where the cable 10 is partially hidden in a functional element of the ear level part 2.

The cable 10 may be equipped with a plug 11 at one end or at both ends to releasably connect the cable 10 to the earl level part 2 and/or to the behind the ear part 15. Having a plug 11 at both ends allows for exchanging the cable 10 without exchanging the whole ear level part 2.

In an exemplary embodiment, a groove 12 is arranged in the retention element 8, the groove following the course of the retention element 8 and configured to receive the cable 10. A width of the groove 12 may be chosen to provide a tight fit such that the cable 10 does not inadvertently fall out of the groove 8. In an exemplary embodiment, the groove 8 is arranged in a medial side of the retention element 8 so that it is hidden when the ear level part 2 is installed in a user's ear 20.

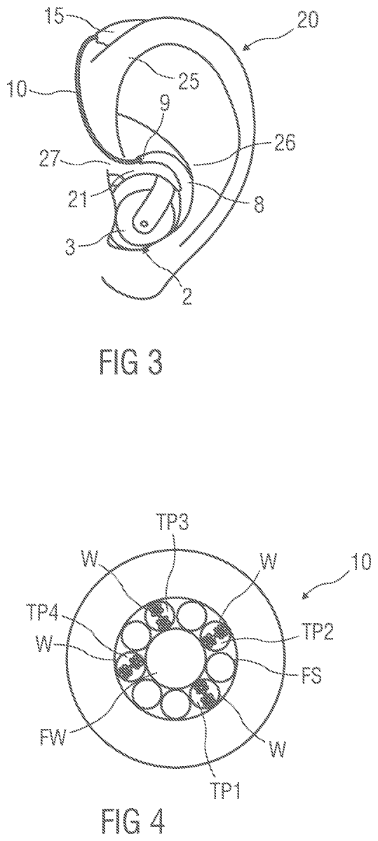

FIG. 3 is a schematic view of an ear 20 with the hearing device 1 installed. The ear level part 2 is arranged with the dome 16, i.e. the socket 6 and collar 7, within the ear canal or the entrance thereof and with the body 3 within the concha 21 such that the retention element 8 is supported by the antihelix 26. The end section 9 of the retention element 8 and the cable 10 emerging therefrom at least approximately point toward the incisura anterior 27. Before reaching the incisura anterior 27 the cable 10 may bend upward and run around part of the helix 25 to the behind the ear part 15 which is positioned behind the ear 20.

Positioning the dome 16 at the entrance of the ear canal may reduce the level of irritation that typically occurs when using standard RIC domes that reside deeper inside the ear canal.

In an exemplary embodiment, the cable 10 may also be configured as follows:

FIG. 4 is a schematic sectional view of a cable 10, in particular for use in a hearing device 1, e.g. for connecting a transducer module 30 comprising multiple transducers such as one or more microphones and/or one or more receivers.

A specific physical arrangement of conductors in the cable 10 is proposed to minimize the effects of crosstalk/cross-contamination and noise pickup. In the example given herein, a total of eight conductors are assumed, in the following configuration:
two input lines TP1 as a twisted pair, for example two microphone signal lines,
two power supply lines TP2 as a twisted pair, for example a positive voltage supply line and a negative voltage supply line for a microphone,
two ground lines TP3 as a twisted pair, for example double-redundant ground for shielding,
two output lines TP4 as a twisted pair, for example two receiver drive lines.

In other embodiments, the signals may be distributed in a different way to the twisted pairs TP1 to TP4. For example, twisted pair TP1 may carry a signal line and one power line and twisted pair TP2 may carry another signal line and another power line.

These eight lines TP1 to TP4 are wound around a central core wire FW which may be made of a malleable material, e.g. a stainless-steel forming wire, that allows shaping of the cable 10 to suit a given physical application allowing for flexibility and shaping by a user.

To minimize crosstalk and noise, the eight lines are arranged around the core wire FW as twisted pairs TP1 to TP4 with filler strands FS which may be made of a non-conductive material, e.g. clear polyamide (nylon) filler wires, in between the pairs to reduce coupling and produce a smoother outer finish around the entire cable assembly.

In the embodiment shown one filler strand FS is arranged between the twisted pairs TP1 and the twisted pairs TP2, one filler strand FS is arranged between the twisted pairs TP2 and the twisted pairs TP3, one filler strand FS is arranged between the twisted pairs TP3 and the twisted pairs TP4, and two filler strands FS are arranged between the twisted pairs TP4 and the twisted pairs TP1. The skilled person readily understands that different configurations, in which different numbers of filler strands FS are arranged between the twisted pairs TP1 to TP4 are possible.

Moreover, the skilled person readily understands that though four twisted pairs TP1 to TP4 or eight conductors are used in the illustrated embodiment, the solution is applicable to any arrangement if there is an even number of conductors. If the number of conductors is odd, the solution may be applied to an even number subset of the conductors.

To demonstrate the efficacy of the twisted pair scheme and as an example, some measurements of crosstalk are shown in the schematic diagram of FIG. 5 for different conductor/signal assignments. FIG. 5 shows electrical crosstalk at 0 dB FS, wherein equivalent acoustic input EAI in dB SPL is shown over frequency f. In this example, these measurements have been obtained by driving a nominally 200 Ohm receiver with a 900 mV RMS signal across the frequencies shown. A microphone (sensitivity −37.0 dB re 1V/1 Pa) had its output, power supply and ground lines connected through the cable 10, parallel to the receiver signals. The crosstalk magnitude was taken as the microphone output voltage with no acoustic signal; only the crosstalk-induced signal was present (alongside inherent electrical noise). This voltage was then converted to dB SPL to produce the resulting plots.

The equivalent acoustic input EAI as measured by the microphone input stage shows a decrease of about 15 dB across most of the frequency range measured for curve C1 referring to the receiver drive lines arranged as twisted pair TP4 as opposed to curve C2 referring to the receiver drive lines arranged non-twisted.

There may be some variability depending on which conductors carry which signals around the core wire FW and this is especially evident in the non-twisted pair cases. Having microphone and receiver lines further apart on the cable cross-section appears to decrease the crosstalk. Nonetheless, the twisted pair configuration yields much lower crosstalk overall.

It should also be noted that the crosstalk increases with frequency so that any harmonics of the drive signal will be more strongly coupled to the microphone than the fundamental. Reducing crosstalk then has the added benefit of reducing the distortion coupled back to the microphone output.

In an exemplary embodiment the core wire FW may be grounded to improve noise reduction.

In an exemplary embodiment a shielding wrap W may be arranged around the interfering signals, e.g. TP1 and/or TP4, to improve noise reduction.

In an exemplary embodiment at least one end of the cable 10 may comprise a connector comprising a plurality of pins respectively electrically connected to at least one of the conductors of the cable 10. In an exemplary embodiment both ends of the cable 10 may comprise a connector.

In an exemplary embodiment the core wire FW may be mechanically fixed to the connector.

In an exemplary embodiment, a kit may be provided, comprising two, three or more cables 10 as described above, the cables 10 having different lengths. This may facilitate a hearing aid professional to customize a hearing aid to the geometry of an ear 20 of a user.

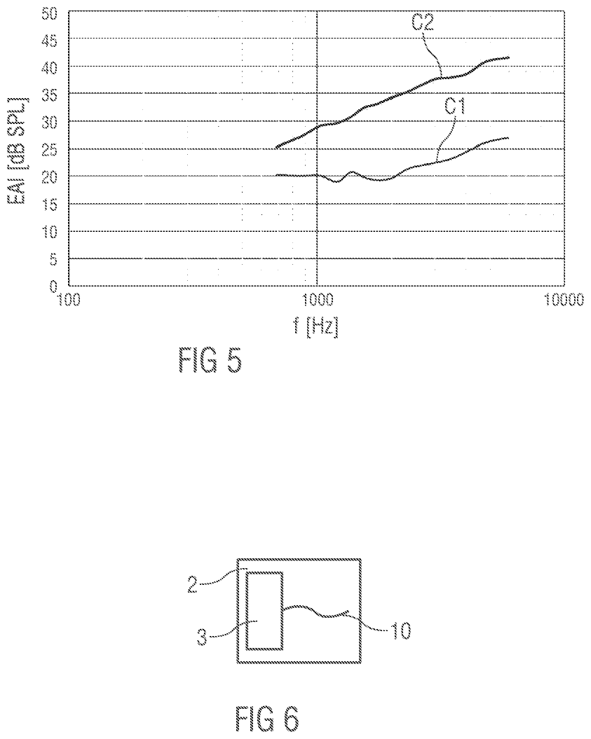

FIG. 6 is a schematic view of a hearing device 1 having a transducer module 30 or another electronic component or module such as a sensor or sensor module and a cable 10 according to FIG. 4 connecting the transducer module 30.

### LIST OF REFERENCES

1 hearing device
2 ear level part
3 body
6 socket
7 collar
8 retention element
9 end section
10 cable
11 plug
15 behind the ear part
16 dome
20 ear
21 concha
25 helix
26 antihelix
27 incisura anterior
30 transducer module
C1 to C10 curve
EAI equivalent acoustic input
f frequency
FS filler strand
FW core wire
TP1 twisted pair, input lines
TP2 twisted pair, power supply lines
TP3 twisted pair, ground lines
TP4 twisted pair, output lines
W shielding wrap

What is claimed is:

1. An ear level part for a hearing device, comprising a body configured to be worn within a concha of a user's ear and a retention element arranged on the body and configured to bear against an antihelix of the user's ear, wherein a cable is arranged to electrically connect the ear level part with a behind the ear part of the hearing device, wherein the cable is run within the retention element and emerges from an end section thereof.

2. The ear level part of claim 1, wherein the retention element has an arc shape running around part of a circumference of the body.

3. The ear level part according to claim 1, wherein a distance between the body and the retention element increases over at least part of a course of the retention element.

4. The ear level part according to claim 1, wherein the retention element has a generally oval cross section in a transverse direction to its course at least over a part of its course.

5. The ear level part according to claim 1, wherein a course of the retention element is adapted to at least in part follow a course of the antihelix when the body of the ear level part is arranged in the concha.

6. The ear level part according to claim 1, wherein an end section of the retention element opposite an end emerging from the body is configured to at least approximately point toward an incisura anterior of the ear when the body of the ear level part is arranged in the concha thereof.

7. The ear level part according to claim 1, wherein the retention element is integrally formed with the body.

8. The ear level part according to claim 1, wherein at least one of the retention elements and the body is made of die cast silicone having a shore A hardness of less than 50.

9. The ear level part according to claim 1, wherein a groove is arranged in the retention element, the groove following a course of the retention element and configured to receive the cable.

10. The ear level part of claim 9, wherein a width of the groove and a diameter of the cable are chosen to provide a tight fit.

11. The ear level part according to claim 9, wherein the groove is arranged in a medial side of the retention element.

12. The ear level part according to claim 1, wherein the cable is a flexible cable.

13. The ear level part according to claim 1, wherein at least one of two ends of the cable is equipped with a plug.

14. The ear level part according to claim 1, wherein at a medial end of the body a dome is arranged, the dome comprising a socket and a collar, the collar being arranged at a medial end of the socket generally extending back in a distal direction thus at least partially enclosing the socket, wherein the collar is configured to flare in the distal direction.

15. A hearing device, comprising an ear level part according to claim 1 and a behind the ear part electrically connected to the ear level part by the cable.
